(19) United States
(12) Patent Application Publication
(10) Pub. No.: US 2006/0215321 A1
(43) Pub. Date: Sep. 28, 2006

(54) Recording disk cartridge

(75) Inventors: Yasushi Endo, Odawara (JP); Kengo Oishi, Odawara (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/330,292

(22) Filed: Jan. 12, 2006

(30) Foreign Application Priority Data
Mar. 22, 2005 (JP) 2005-081349

(51) Int. Cl. G11B 23/03

(52) U.S. Cl. 360/133

(57) ABSTRACT

The recording disk cartridge with recording disk media and a cartridge case for housing the media is equipped with a base frame that surrounds a radial directional outside of the media, configures a sidewall of the case, and has a side opening that makes the media front outside; a lower plate that is disposed below the media and configures a lower wall of the case; an upper plate that is disposed above the media and configures an upper wall of the case; a rotary shutter that opens and closes the side opening; and a swing shutter that is disposed between the media and the lower plate, swings according to the rotational movement of the rotary shutter, and opens and closes the chucked center hole, wherein the rotary shutter comprises a reinforcement plate only at a lower side thereof.

### BACKGROUND OF THE INVENTION

1. Field of the Invention

The present invention relates to a recording disk cartridge that houses recording disk media in a cartridge case.

2. Description of the Related Art

Conventionally, a recording disk cartridge is known that houses in a cartridge case: recording disk media such as flexible magnetic disk media where magnetic layers are formed on both faces of a disk-form support body consisting of such a polyester sheet; magneto-optical disk media; and phase-change disk media. These pieces of recording disk media are made to be higher density recording year by year; and their recording track width is becoming narrower and their recording length shorter. Therefore, a read error is apt to occur in a magnetic disk cartridge only if a slight amount of dust intervenes between the magnetic disk media and a magnetic head. In addition, although the optical disk media is said to be comparatively strong for dust, in higher recording density, as a result of a numerical aperture of a lens of an optical pickup, it becomes necessary to near the media and the lens, and after all the read error is apt to occur due to the dust.

As a portion of dust invading a recording disk cartridge are cited such an access opening provided at a cartridge case in order to make a magnetic head and an optical pickup access recording disk media; and a chucked center hole provided at center of the cartridge case in order to couple a spindle of a disk drive with the recording disk media. Then a conventional recording disk cartridge is configured so as to close the access opening and the chucked center hole in no use thereof in order to prevent dust from invading inside of its cartridge case (for example, see Japanese Patent Laid-Open Publication No. 2004-013921, 2002-063778, and 2004-348885).

However, because in the conventional recording disk cartridge a shutter for closing the access opening and the chucked center hole is actuated outside the cartridge case, there is a possibility that the shutter is hooked into other things and opens in any of taking along and keeping the cartridge. In addition, because the conventional recording disk cartridge is designed so that the shutter can easily be contacted from outside, there is also a possibility that the shutter is carelessly opened. Then, because in the conventional recording disk cartridge the access opening is provided on an upper face or/and lower face of the cartridge case in parallel with the recording disk media, the media is largely exposed and becomes a state of being easily tainted and damaged when the shutter opens. Furthermore, because in the conventional recording disk cartridge the access opening is provided on the upper face or/and the lower face of the cartridge case, there is also a problem that a rigidity of the cartridge case is lowered and that it is difficult to make the case thinner.

In addition, recently it is requested that a recording disk cartridge is thinner as part of space saving.

Consequently, a recording disk cartridge is strongly requested that prevents dust from invading inside of a cartridge case, and recording disk media from being tainted and damaged as much as possible; and has a higher rigidity and can be made thinner.

### SUMMARY OF THE INVENTION

The present invention is a recording disk cartridge having recording disk media and a cartridge case for housing the recording disk media, and the recording disk cartridge comprises: a base frame that substantially surrounds a radial directional outside of the recording disk media, configures a sidewall of the cartridge case, and has a side opening that makes the recording disk media front outside; a lower plate that is disposed below the recording disk media and configures a lower wall of the cartridge case, wherein a chucked center-hole is formed in order to couple a spindle of a disk drive with the recording disk media; an upper plate that is disposed above the recording disk media and configures an upper wall of the cartridge case; a rotary shutter that opens and closes the side opening by rotating within the cartridge case; and a swing shutter that is disposed between the recording disk media and the lower plate and is engaged in the rotary shutter, thereby swings in response to the rotational movement of the rotary shutter, and opens and closes a chucked center hole, wherein the rotary shutter comprises a reinforcement plate only at a lower side thereof.

In accordance with such the recording disk cartridge the side opening that makes the recording disk media front outside, that is, the access opening for a magnetic head and an optical pickup accessing the recording disk media are provided at the base frame that forms the sidewall of the cartridge case; and the upper plate and the lower plate configure the upper wall and lower wall of the cartridge case, respectively, and occlude the upper side and lower side of the base frame. Therefore, it is prevented that the rigidity of the cartridge case is lowered due to the formation of the access opening on any of the upper face and the lower face. In addition, because the access opening is formed only at the sidewall, even when a user opens the rotary shutter that opens and closes the opening, she or he can only see a rim of an outer perimeter of the recording disk media from the opening and it is difficult for her or him to directly touch a recording face of the recording disk media. Therefore, the recording face of the recording disk media can be prevented from being tainted and damaged. In addition, because a size of the access opening suffices to be minimum, it is difficult for dust to invade inside of the cartridge case.

In addition, the swing shutter for opening and closing the chucked center hole is positioned between the lower plate and the flexible disk, that is, more inside than the lower plate, and thereby, other things are not hooked into the shutter in any of taking along and housing the recording disk cartridge.

Furthermore, the rotary shutter comprises the reinforcement plate only at the lower side, and thereby, while ensuring a sufficient rigidity thereof, the shutter suppresses an increase of its thickness. In addition, the rotary shutter comprises the reinforcement plate only at the lower side, and thereby it is enabled to assemble the recording disk cartridge by a method of building up the rotary shutter, the recording disk media, and the upper plate from the lower plate and to realize a simplification of the assembly.

Meanwhile, although because the disk drive usually accesses a chuck portion of the recording disk media from below, the side where there exists the center hole for the access is made below for convenience in the upper plate and the lower plate in the present invention, it goes without saying that the lower plate of the invention can be used with being directed in a horizontal direction or upward.

In the recording disk cartridge it can be designed that the rotary shutter comprises: an outer perimeter wall made of resin substantially surrounding a radial directional outside of the recording disk media; and the reinforcement plate made of metal fixed at a lower side of the outer perimeter wall. In addition, the outer perimeter wall and the reinforcement plate can be integrally molded by insert molding, and thereby be made a firmly fixed state.

In addition, it can be configured that the reinforcement plate has a cylindrical engagement protrusion protruded toward a lower side to engage in the swing shutter; and a liner for cleaning is provided on an upper face, and thereby an opening of the engagement protrusion is occluded.

In accordance with such the configuration, even in a case that there exists the opening by the cylindrical engagement protrusion, the opening is occluded by the liner, and thus it results in becoming difficult for dust to invade an upper chamber of the reinforcement plate where the recording disk media is put.

Then the engagement protrusion can be formed by barring process of a metal plate configuring the reinforcement plate.

### BRIEF DESCRIPTION OF THE DRAWINGS

FIG. 1 is an appearance perspective view showing a magnetic disk cartridge and a disk drive related to an embodiment of the present invention.

FIG. 2 is an appearance perspective view where the magnetic disk cartridge is seen from below in a state of an access opening being opened.

FIG. 3 is an exploded perspective view of the magnetic disk cartridge.

FIGS. 4A and 4B show enlarged explode perspective views of a base frame; FIG. 4A is the perspective view seen from above; and FIG. 4B is the perspective view seen from below.

FIG. 5A is a V-V sectional view in FIG. 1; FIG. 5B is a view of a magnetic disk cartridge related to a variation example corresponding to the V-V sectional view in FIG. 1.

FIG. 6 is a plan view of the magnetic disk cartridge in a state of an upper plate being removed.

FIG. 7 is a perspective view where a rotary shutter is seen from below.

FIGS. 8A and 8B show movements of the rotary shutter; FIG. 8A is a perspective view where a closed state of the rotary shutter is seen from a left front; and FIG. 8B is a perspective view where an opened state of the rotary shutter is seen from the left front.

FIGS. 9A and 9B show sectional views of the magnetic disk cartridge; FIG. 9A is a state of the rotary shutter being closed; and FIG. 9B is a state of the rotary shutter being opened.

### DESCRIPTION OF THE MOST PREFERRED EMBODIMENTS

Here will be described an embodiment of the present invention in detail, referring to drawings as needed. In the embodiment will be described a case of a magnetic disk cartridge where magnetic disk media is adopted as an example of recording disk media.

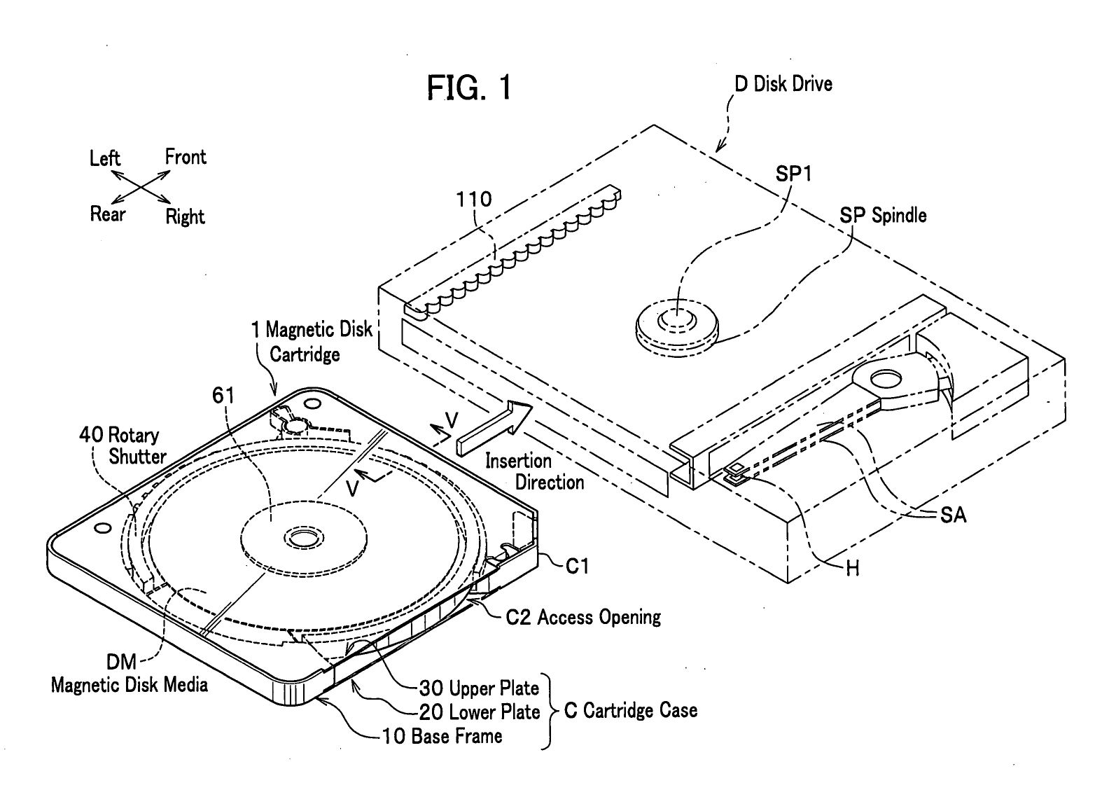

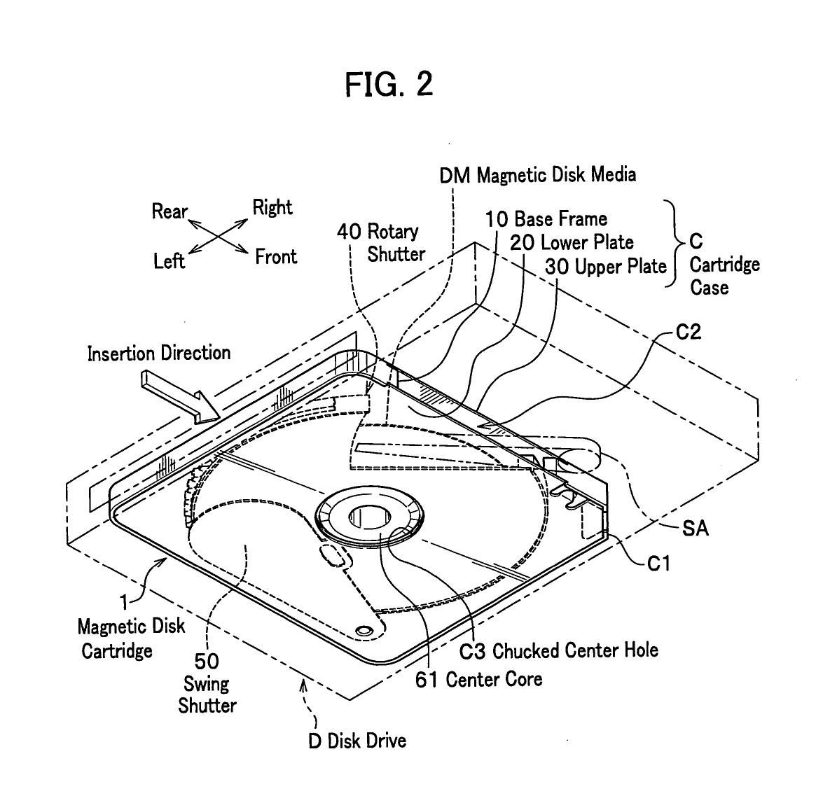

FIG. 1 is an appearance perspective view showing a magnetic disk cartridge 1 and a disk drive D related to an embodiment of the present invention; FIG. 2 is an appearance perspective view where the magnetic disk cartridge 1 is seen from below in a state of an access opening being opened. Meanwhile, in a description below, with respect to up/down directions, making it a standard a typical use state of the magnetic disk cartridge, vertical directions for faces of the magnetic disk media are assumed to be the up/down directions for convenience, and a direction where there exists a chucked center-hole for exposing a center core outside is assumed to be the down direction. In addition, assuming an insertion direction of the magnetic disk cartridge 1 as a front, the embodiment will be described, using directions of front/rear and left/right shown in FIG. 1.

As shown in FIG. 1, the magnetic disk cartridge 1 is designed to house a magnetic disk media DM within a cartridge case C. The cartridge case C comprises the base frame 10, a lower plate 20 jointed to a lower side of the base frame 10, and an upper plate 30 jointed to an upper side of the base frame 10.

In the cartridge case C an external form thereof is a substantially rectangular card-form in a plan view. One corner of the rectangle is cut off like a chamfer and forms a chamfer portion C1, and is made a marker for an insertion direction into the disk drive D. Although the insertion direction is set to become the right-front direction in the plan view, it is not limited thereto.

In an orthogonal direction for the insertion direction, at a side portion in the right direction in FIG. 1, is formed an access opening C2 as a side opening for making the magnetic disk media DM fronted outside. A swing arm SA, which the disk drive D has and which has a magnetic head H at its tip, proceeds inside the cartridge case C from the access opening C2 and accesses the magnetic disk media DM.

The access opening C2 is closed by a rotary shutter 40 in no use of the magnetic disk cartridge 1, for example, in keeping the cartridge 1, and is opened in use by rotating the shutter 40.

As shown in FIG. 2, at center of a lower side of the cartridge case C is formed a chucked center-hole C3 for coupling a spindle SP (see FIG. 1) of the disk drive D with the magnetic disk media DM. The chucked center-hole C3 is closed by a swing shutter 50 in no use of the magnetic disk cartridge 1, is opened by swinging the swing shutter 50 in use, and exposes a center core 61 (chuck portion 61a) outside, the core 61 having a chuck portion which the magnetic disk media DM has.

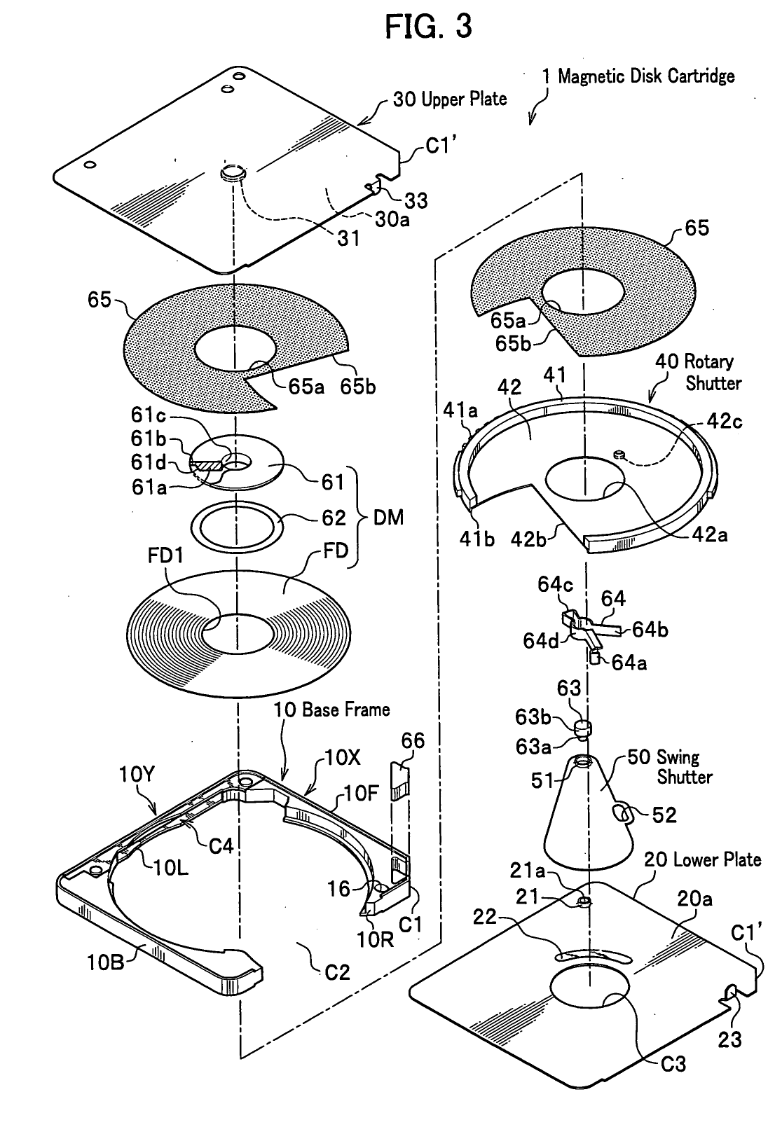

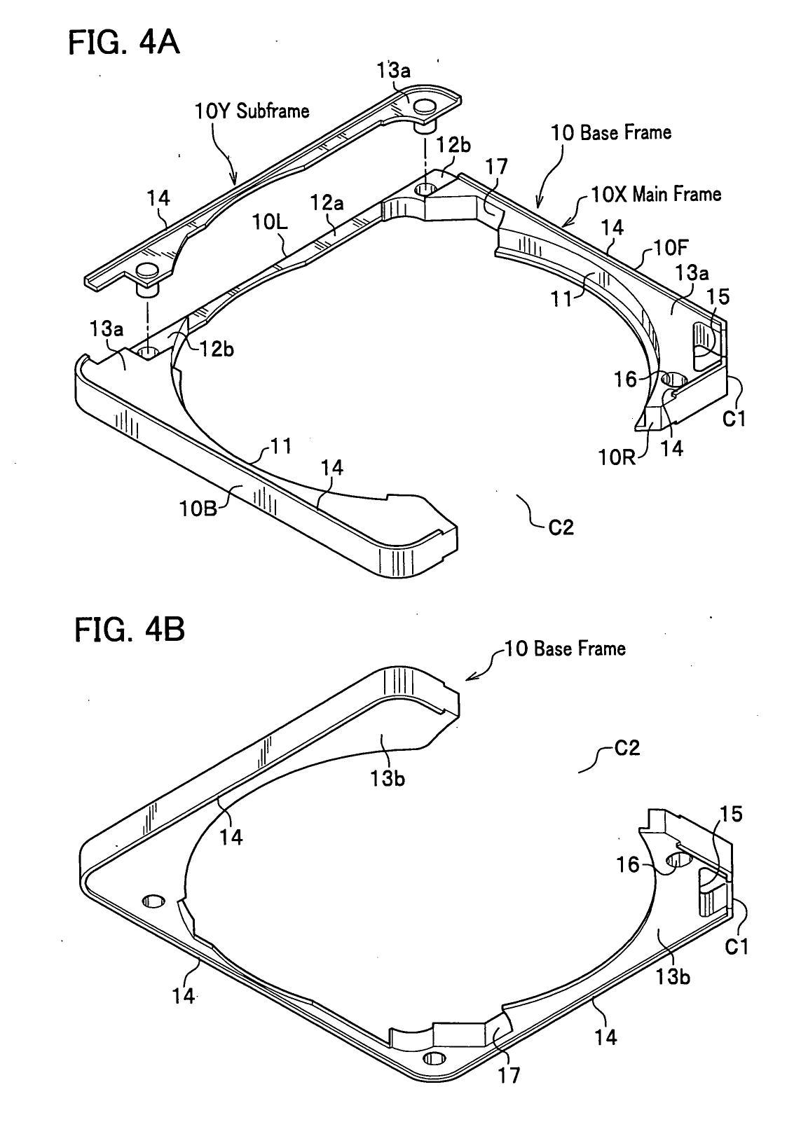

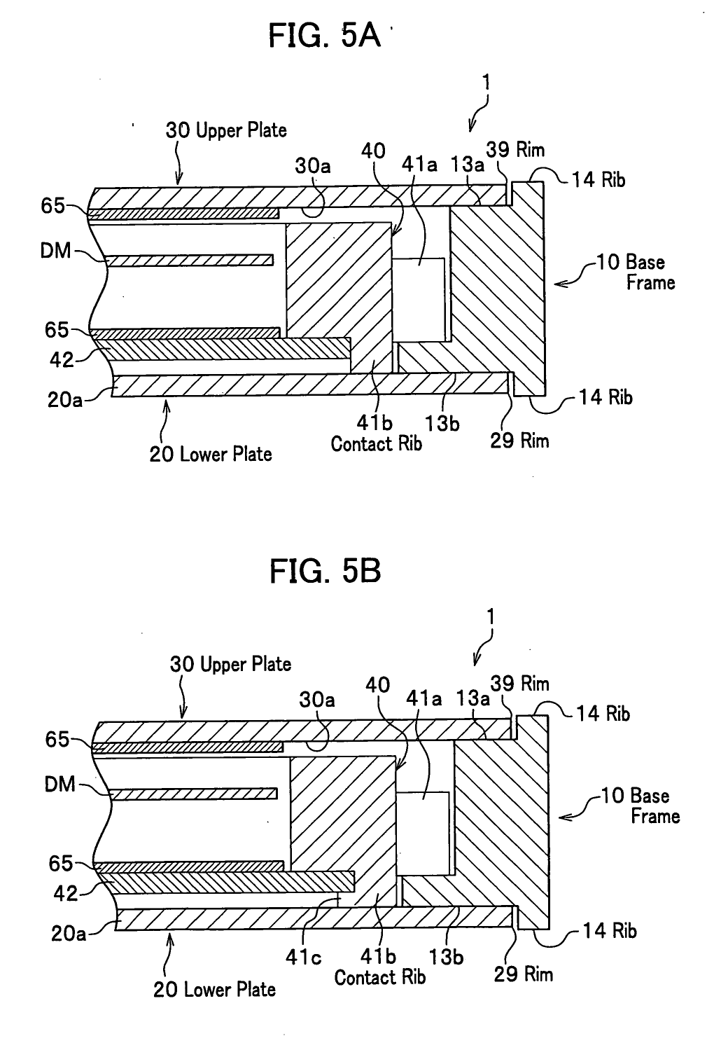

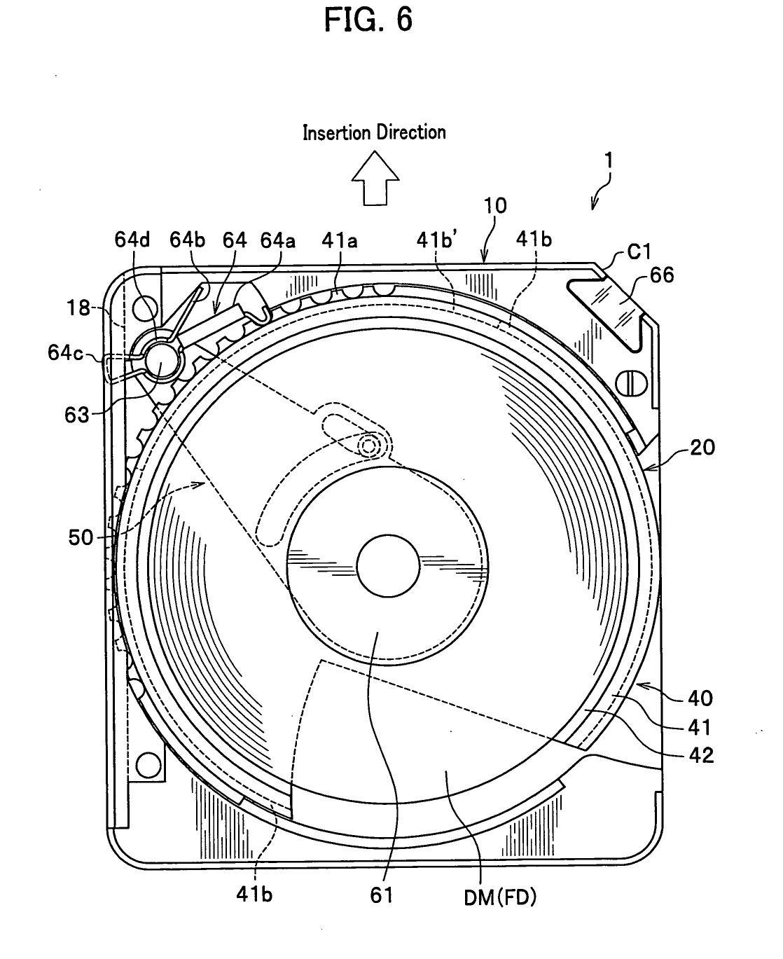

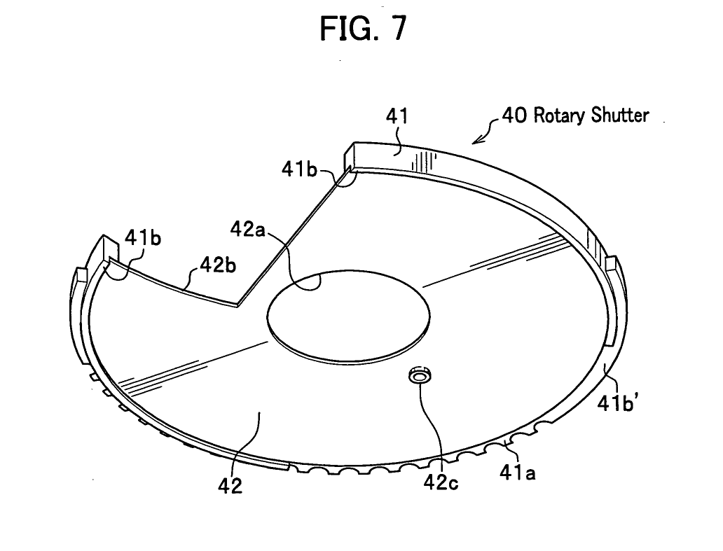

Next will be described the magnetic disk cartridge 1 in detail, referring to FIGS. 3 to 7. FIG. 3 is an exploded perspective view of the magnetic disk cartridge 1. FIGS. 4A and 4B show enlarged explode perspective views of the base frame 10; FIG. 4A is the perspective view of the base frame 10 seen from above; and FIG. 4B is the perspective view the base frame 10seen from below. In addition, FIG. 5A is a V-V sectional view in FIG. 1; FIG. 5 B is a view of the magnetic disk cartridge 1 related to a variation example corresponding to the V-V sectional view in FIG. 1. FIG. 6 is a plan view of the magnetic disk cartridge 1 in a state of the upper plate 30 being removed; FIG. 7 is a perspective view where the rotary shutter 40 is seen from below.

As shown in FIG. 3, the base frame 10 configures a sidewall of the cartridge case C and is a C-letter form member formed into a cutoff form where one edge of a rectangular frame substantially surrounding the magnetic disk media DM is cut off. To be more precise, the access opening C2 is formed at a right edge 10R. Because the access opening C2 is enough if it is opened at the side portion of the base frame 10, it is not always necessary to form the opening C2 by cutting off one edge, and for example, it is also available to form the opening C2 by thinning part of the edge or providing a slit at the side portion of the edge. In addition, a shutter actuation opening C4 like a slit is formed at a left edge 10L along the front and rear thereof. The shutter actuation opening C4 becomes an opening where the rotary shutter 40 is exposed outside.

As shown in FIG. 4A, an inner perimeter of the base frame 10 has a cylindrical inner wall 11 matching an outer perimeter of the rotary shutter 40 (see FIG. 3), and the inner wall 11 supports the rotary shutter 40 so as to be rotatable. Left-front part out of the inner perimeter of the base frame 10 is depressed more outside than the cylindrical inner wall 11. The depressed portion is a spring housing portion 17 for housing a lock spring 64 (see FIG. 3) described later.

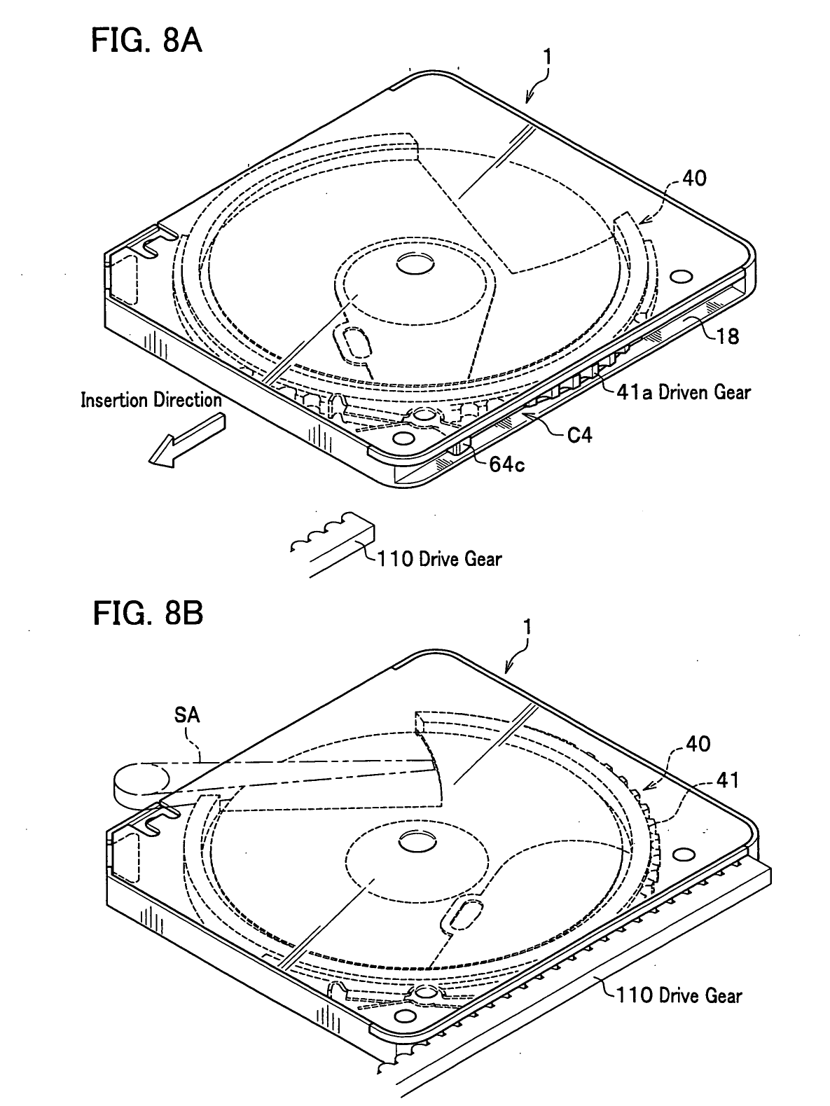

The base frame 10 is designed to be divided into a main frame 1OX and a subframe 10Y. The subframe 10Y is a slit-like member configuring an upper side of the shutter actuation opening C4. A left edge 10L of the main frame 1OX corresponds to the subframe 10Y, and is formed to be thinner in order to form the shutter actuation opening C4 (the left edge 10L is assumed to be a “thin piece portion 12a”). At both ends of the left edge 10L of the main frame 10X are formed joint pedestals 12b higher than the thin piece portion 12a by one step. By connecting the subframe 10Y to the joint pedestals 12b, the shutter actuation opening C4 like the slit is formed between the thin piece portion 12a and the subframe 10Y (see FIG. 3). In addition, seen from outside, both ends in front/rear directions of the shutter actuation opening C4 are designed to be a groove 18 of a predetermined width continuing into the shutter actuation opening C4 (see FIG. 8A).

Meanwhile, a height of the joint pedestals 12b is set so that an upper face 13a of the subframe 10Y becomes a same height as upper faces 13a of the main frame 10X. In addition, in the embodiment although the base frame 10 is designed to connect two members of the main frame 10X and the subframe 10Y, they may also be integrally molded and be designed to be divided into not less than three members.

In addition, at rims of an outer perimeter of the base frame 10 are formed ribs 14 across substantially all outer perimeter toward up/down directions. Heights of the ribs 14 from the upper faces 13a and lower face 13b of the base frame 10 are designed to be same as or higher than each thickness of the lower plate 20 and the upper plate 30. Therefore, if the lower plate 20 and the upper plate 30 are joined with the base frame 10, a rim 29 of the lower plate 20 and a rim 39 of the upper plate 30 are concealed by the ribs 14 as shown in FIG. 5A, and result in not being hooked into the rims 29 and 39 in handling the magnetic disk cartridge 1. Therefore, it becomes difficult for the lower plate 20 and the upper plate 30 to peel off from the base frame 10.

From such the meaning, it is preferable that the heights of the ribs 14 from the respective upper faces 13a and lower face 13b of the base frame 10 are higher than respective thicknesses of the upper plate 30 and the lower plate 20.

As shown in FIG. 4A, at the chamfer portion C1 of the base frame 10 is formed a dove tail depression 15 of which a width becomes wider as it goes back. A functional component is stored in the depression 15. For example, in the depression 15 can be disposed a transparent plastic piece (assumed to be an “identification member 66”) corresponding thereto as an optical component (see FIG. 3). Such the identification member 66 may also be used for the identification of the magnetic disk cartridge 1, changing the member 66 according to a kind of the magnetic disk cartridge 1. For example, if changing any of a color and a reflectivity of the identification member 66, it is enabled to identify the magnetic disk cartridge 1 by detecting the color and reflectivity thereof. Thus, the chamfer portion C1 can be used as an identification region. An RFID (Radio Frequency Identifier) tag may also be used as the identification member 66, not limited to a case that such the optical component is used. In a case that the RFID tag is disposed at the chamfer portion C1, it is enabled to identify the magnetic disk cartridge 1 by accessing the tag from two directions of front and right of the cartridge 1.

At rear of the depression 15 of the base frame 10 is formed a joint through hole 16 penetrated in up/down directions. The joint through hole 16 is used when the lower plate 20 and the upper plate 30 are jointed.

Although it is preferable to select a resin as a material of the base frame 10 from easiness of molding a complicated form, it is also available to select metal, ceramics, and the like.

As shown in FIG. 3, the lower plate 20 is a substantially rectangular plate member configuring a lower wall of the cartridge case C and has at center thereof the chucked center hole C3 for exposing the center core 61 outside. A size of the lower plate 20 in the plan view is slightly larger than the rotary shutter 40, and the outer perimeter of the rotary shutter 40 is positioned more inside than the rim portion of the lower plate 20. At the right-front corner of the lower plate 20 is formed a chamfer portion C1′, imitating the chamfer portion C. In addition, in the upper face 20a of the lower plate 20, in the vicinity of the left-front corner are formed a protrusion 21 for supporting the swing shutter 50 to be able to swing; and an evasion groove 21 for evading an interference with an engagement protrusion 42c which the rotary shutter 40 has.

The protrusion 21 is formed into a cylindrical form by barring process. Outside the protrusion 21 is fitted a bearing 51 of the swing shutter 50, and in an inner cylindrical portion 21a is fitted a pull-out stopper pin 63.

The evasion groove 22 is positioned on concentric arc with the chucked center hole C3. This is because the engagement protrusion 42c concentrically rotates with center of the cartridge case C (center of the magnetic disk media DM), following a rotational movement of the rotary shutter 40. A depth of the evasion groove 22 may have a depth that can evade an interference with the engagement protrusion 42c. Meanwhile, in a case that the upper face 20a of the lower plate 20 (equivalent to an inner face of the cartridge case C) is sufficiently smooth, a friction by an abrasion between the engagement protrusion 42c and the lower plate 20, and a wear powder does not occur, the evasion groove 22 may not be provided.

In the vicinity of the right-front of the lower plate 20 is formed a joint claw portion 23. The portion 23 generates a joint force of the base frame 10 and the lower plate 20 by being pressed into the joint through hole 16 of the base frame 10. Although as a joint of the base frame 10 and the lower plate 20 there exist methods such as use of an adhesive, pressed-fit-in of the lower plate 20 and the ribs 14, and thermal caulking after forming a caulking protrusion at the base frame 10 and fitting it in an appropriate opening of the lower plate 20, a method thereof is not specifically limited.

The upper plate 30 is a substantially rectangular plate member configuring the upper wall of the cartridge case C, and at a right-front corner thereof the chamfer portion C1′ is formed, imitating the chamfer portion C. A size of the upper plate 30 in the plan view is slightly larger than the rotary shutter 40, and the outer perimeter of the rotary shutter 40 is positioned more inside than the rim portion of the upper plate 30. At corner of a lower face 30a of the upper plate 30 is formed a protrusion 31 for fixing the center core 61 in no use of the magnetic disk cartridge 1. In addition, in the vicinity of the right-front corner of the upper plate 30 is formed a joint claw portion 33 protruding downward, corresponding to the joint through hole 16. The joint claw portion 33 generates a joint force of the base frame 10 and the upper plate 30 by being pressed into the joint through hole 16 of the base frame 10. A joint of the base frame 10 and the upper plate 30 can also be performed by other methods same as those of the base frame 10 and the lower plate 20.

To the lower face 30a of the upper plate 30, a portion equivalent to an inner face of the cartridge case C, are affixed liners 65 for cleaning a flexible disk FD. As a material of the liners 65 are preferably used a non-woven cloth, a sheet where an ultra high molecular polyethylene is foamed, and the like. The liners 65 are a circular sheet-form member and has at center thereof a circular through hole 65a matching a size of the center core 61. In addition, matching a movement range of the swing arm SA, a cutoff 65b is formed for preventing an interference with the swing arm SA.

Although the material of the lower plate 20 and the upper plate 30 is not specifically limited, a needed rigidity thereof can be ensured, even if they are thin, by configuring at least one or preferably both with metal, for example, stainless steel.

In addition, the base frame 10, the lower plate 20, and the upper plate 30 are not configured as respective separate members; but the base frame 10 and the lower plate 20 may also be integrally molded by a resin, an aluminum alloy, and a magnesium alloy; and the base frame 10 and the upper plate 30 may also be integrally molded by these materials.

Furthermore, in a case that a form of the base frame 10 is complicated and has an undercut form, it is also available to integrally mold one part of the base frame 10, for example, the main frame 10X and the lower plate 20; and to integrally mold the other part of the base frame 10, for example, the subframe 10Y and the upper plate 30. Thus, by designing the base frame 10 as a divided configuration, die-cutting is made smooth, and thereby it is enabled to heighten a form accuracy of a product.

The rotary shutter 40 comprises a C-letter shutter member 41 and a reinforcement plate 42 jointed to a lower side of the member 41.

The shutter member 41 is a member by injection-molding, for example, a resin, wherein as shown in FIG. 6, a driven gear 41a is formed across about one third of an outer perimeter thereof. The driven gear 41a is exposed outside from the shutter actuation opening C4, and engages with a drive gear 110 (see FIG. 1), which the disk drive D has, when the magnetic disk cartridge 1 is inserted in the disk drive D. Accordingly, according to an insertion movement of the magnetic disk cartridge 1, it is enabled that the rotary shutter 40 is rotated by the drive gear 110 and is opened.

As shown in FIG. 7, in the shutter member 41 a contact rib 41b is formed along a lower rim of an outer perimeter thereof. A lower end face of the contact rib 41b contacts the lower plate 20 on a constant circumference (see FIG. 5A and meanwhile, the contact rib 41b is shown in a displacement thereof), and thereby, it is enabled that the rotary shutter 40 smoothly rotates for the lower plate 20. However, the contact rib 41b is not formed at whole circumference of the shutter member 41, that is, a definite range opposing a portion cut off like a C-letter, wherein a window portion 41b′ is formed. The window portion 41b′ is formed so that the shutter member 41 does not interfere a movement of the swing shutter 50. To be more precise, as shown in FIG. 6, because the swing shutter 50 is supported outside a radial direction of the shutter member 41 through a shaft and swings between the rotary shutter 40 (shutter member 41) and the lower plate 20, an interference between the swing shutter 50 and the shutter member 41 (contact rib 41b) is prevented by cutting off part of the contact rib 41b that is a contact portion of the lower plate 20 and the shutter member 41. Thus a smooth movement of the swing shutter 50 is enabled.

Meanwhile, although the contact rib 41b is not limited to one formed as a continuous rib and can be formed like an intermittent protrusion, the rib 41b is preferably like the continuous rib in order to prevent dust from invading the cartridge case C from outside.

As shown in FIG. 3, the reinforcement plate 42 is a substantially circular member consisting of a metal plate, for example, such as stainless steel, and comprises a center hole 42a formed at center thereof for inserting through the center core 61, a cutoff 42b matching the movement range of the swing arm SA, and the engagement protrusion 42c protruding downward (side of the swing shutter 50). To an upper face of the reinforcement plate 42 is affixed the liner 65 same as one affixed to the upper plate 30.

The reinforcement plate 42 is a member for reinforcing a rigidity of the shutter member 41 and forming an engagement portion (engagement protrusion 42c in the embodiment) for transmitting a movement of the rotary shutter 40 to the swing shutter 50. The engagement protrusion 42c is formed by performing a barring process to a metal plate for configuring the reinforcement plate 42, and has a cylindrical form. In other words, although in the engagement protrusion 42c an inside hole of the cylinder is opened upward, the opening is occluded by the liner 65 affixed to the upper face of the reinforcement plate 42. Accordingly, it results in becoming difficult for dust to invade the upper chamber of the reinforcement plate 42 where the magnetic disk media DM is put. In addition, because the engagement protrusion 42c is formed by barring process, the reinforcement plate 42 can be cheaply manufactured.

In addition, because the center hole 42a is enough if the center core 61 passes through it, it may be formed larger than in the embodiment, and for example, may also be a continuous opening into the cutoff 42b.

Furthermore, because the cutoff 42b is something for facilitating the swing arm SA to proceed into the cartridge case C, it is not always necessary if there exists a space for the swing arm SA proceeding into the cartridge case C.

The joint of the shutter member 41 and the reinforcement plate 42 can be performed by adhesion, press-in, caulking, gummy substance, and the like. In addition, in injection molding the shutter member 41, the reinforcement plate 42 may also be jointed by insert molding of inserting the reinforcement plate 42. In this case, as shown in FIG. 5B, if a wrap-hold portion 41c for wrapping and holding the peripheral rim portion of the reinforcement plate 42 in advance, connected to the contact rib 41b, the reinforcement plate 42 and the shutter member 41 can be firmly jointed. Furthermore, in this case, making the peripheral rim portion of the reinforcement plate 42 not a smooth circular form but a protrusion/depression form, the reinforcement plate 42 and the shutter member 41 can be more firmly jointed.

The swing shutter 50 is a member for opening and closing the chucked center hole C3 of the lower plate 20 as shown in FIG. 3, and is equipped between the lower plate 20 and the rotary shutter 40. The swing shutter 50 is a substantially sectoral plate formed narrower at a base side and wider at a tip side, and the wider portion at the tip has a sufficient size for closing the chucked center hole C3.

At the base of the swing shutter 50 is formed the bearing 51 molded into a cylindrical form. The bearing 51 fits outside the protrusion 21 of the lower plate 20; the swing shutter 50 is swingably supported by the lower plate 20 through a shaft. The pull-out stopper pin 63 is fitted in the inner cylindrical portion 21a of the protrusion 21, and thereby, the swing shutter 50 fitted outside the protrusion 21 of the lower plate 20 is prevented to drop off from the lower plate 20. Meanwhile, the pull-out stopper pin 63 comprises a pin portion 63a and a head portion 63b, and an outer perimeter of the head portion 63b is designed to be an approximately same diameter as that of the bearing 51.

In the swing shutter 50 is formed an engagement hole portion 52 like a substantially long hole. The engagement hole portion 52 engages in the engagement protrusion 42c and plays a function of transmitting the rotational movement of the engagement protrusion 42c to the swing shutter 50. Although the engagement protrusion 42c engaged in the engagement hole portion 52 has a possibility that a tip (lower end) of the protrusion 42c slightly protrudes below the engagement hole portion 52, a smooth movement of the rotary shutter 40 is not blocked because the protruded portion is housed in the evasion groove 22.

In the embodiment, although the engagement hole portion 52 is formed as a through hole, it may also be an engagement portion not limited to the through hole. For example, the engagement hole portion 52 may be formed as not the through hole but a groove (engagement groove portion), and the groove and the through hole are opened to the rim portion of the swing shutter 50. In addition, although the engagement of the rotary shutter 40 and the swing shutter 50 is performed by the engagement protrusion 42c of the shutter 40 and the engagement hole portion 52 of the swing shutter 50, the relation of the protrusion/depression may be reversed. In other words, it is also available to provide the swing shutter 50 with an engagement protrusion protruded toward the rotary shutter 40 and to form in the rotary shutter 40 an engagement hole portion or engagement groove for engaging in the engagement protrusion.

The outer perimeter of the head portion 63b of the pull-out stopper pin 63 and the bearing 51 are designed like one continuous shaft by being formed to be a same diameter, and the continuous shaft supports the lock spring 64 for stopping an unneeded rotation of the rotary shutter 40 in no use of the magnetic disk cartridge 1.

The lock spring 64 comprises a lock leg portion 64a, a spring leg portion 64b, a lock release leg portion 64c, and a bearing portion 64d for making the pull-out stopper pin 63 support these through the shaft. In the lock spring 64, as shown in FIG. 6, a tip of the lock leg portion 64a engages in the driven gear 41a of the shutter member 41; the spring leg portion 64b abuts with the inner perimeter of the base frame 10, to be more precise, the inner wall of the spring housing portion 17. Then in a disposition of the lock release leg portion 64c fronting from the shutter actuation opening C4 to the outside of the cartridge case C, the bearing portion 64d of the lock spring 64 is fitted outside the pull-out stopper pin 63 and the bearing 51 (see FIG. 3). In the state of FIG. 6 the spring leg portion 64b generates an energizing force between itself and the inner wall of the spring housing portion 17, generates a clockwise torque pushing the lock leg portion 64a toward the driven gear 41a, and the lock spring 64 locks the rotation of the rotary shutter 40. On the other hand, when the magnetic disk cartridge 1 is inserted in the disk drive D, the drive gear 110 abuts with the lock release leg portion 64c and rotates the lock leg portion 64a counterclockwise in FIG. 6, and thereby, the lock spring 64 is designed to release the lock of the rotary shutter 40.

As shown in FIG. 3, the magnetic disk media DM comprises the flexible disk FD and the center core 61.

The flexible disk FD is a disc form having a circular opening FD1 at center thereof, and is generally designed to be provided with a magnetic layer on both faces or one face of a support body consisting of a resin film and the like such as polyester. As a material and layer configuration of the support body and the magnetic layer can be used conventionally known ones, selecting as needed; they are not specifically limited.

The center core 61 is a member jointed to the opening FD1 by an affixation member 62 and having a rigidity to some extent. The center core 61 is generally composed of a plated steel plate and a magnetic material such as magnetic stainless steel so that the spindle SP of the disk drive D can be attracted by magnetism.

The center core 61 comprises, as shown in FIG. 3, the chuck portion 61a of a conical trapezoid form, and a flange portion 61b extending outside a radial direction from a larger diameter portion of the chuck portion 61a. In the chuck portion 61a, at center thereof is formed a center hole 61c penetrated in the up/down directions. The center hole 61c is formed to be a size that can engage in a center protrusion SP1 (see FIG. 1) of the spindle SP in order to match a center with the spindle SP. In addition, a size of the center hole 61c also corresponds to that of the protrusion 31 of the upper plate 30. A conical face 61d of an outer perimeter of the chuck portion 61a abuts with the swing shutter 50 when the shutter 50 closes, and becomes an engagement slant for pushing the center core 61 itself into the cartridge case C.

The center core 61 is disposed, making a smaller diameter side of the chuck portion 61a downside, and the flexible disk FD is affixed from downside of the flange portion 61b, that is, a side where the chuck portion 61a protrudes.

The magnetic disk cartridge 1 thus configured is used as follows.

FIGS. 8A and 8B show movements of the rotary shutter 40; FIG. 8A is a perspective view where a closed state of the rotary shutter 40 is seen from a left front; and FIG. 8B is a perspective view where an opened state of the rotary shutter 40 is seen from the left front.

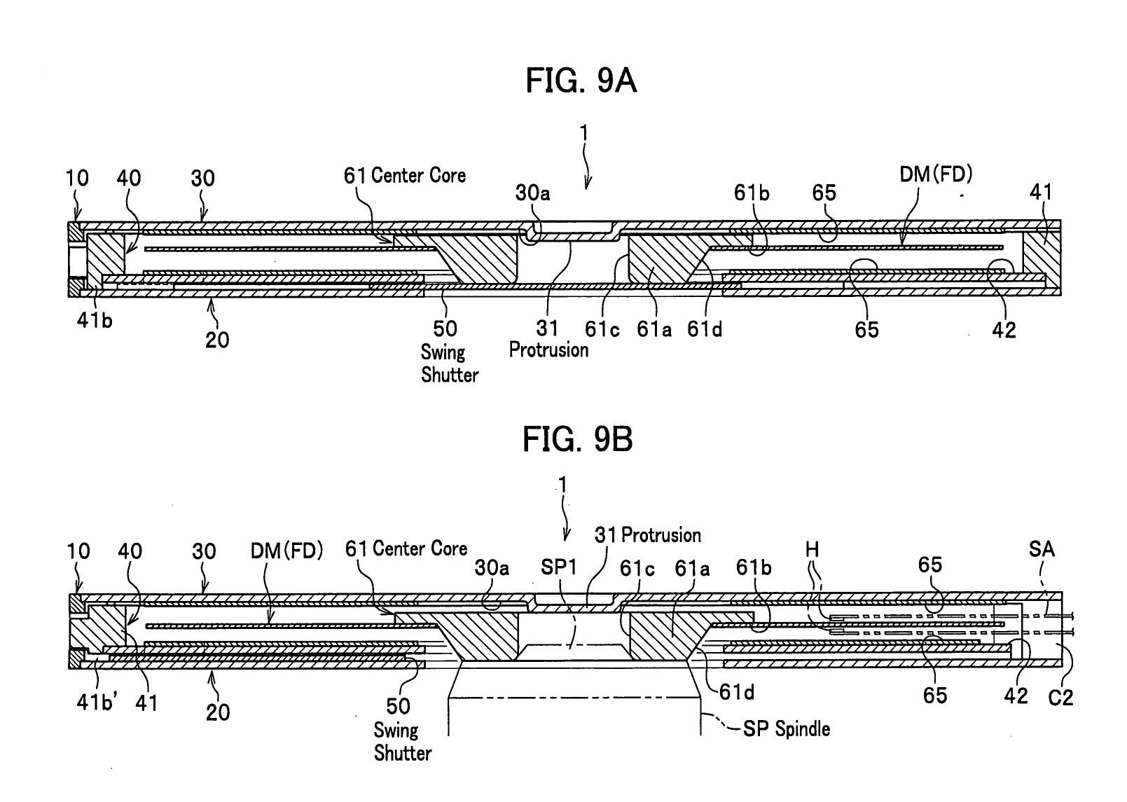

In addition, FIGS. 9A and 9B show sectional views of the magnetic disk cartridge 1; FIG. 9A is a state of the rotary shutter 40 being closed; and FIG. 9B is a state of the rotary shutter 40 being opened.

In the magnetic disk cartridge 1, as shown in FIG. 1, the rotary shutter 40 closes the access opening C2 in no use of the cartridge 1. Then as shown in FIG. 6, the tip of the lock leg portion 64a of the lock spring 64 engages in the driven gear 41a of the shutter member 41, and thereby, the rotary shutter 40 is locked and does not open due to a vibration and the like from outside. Accordingly, it is difficult for dust to invade inside of the cartridge case C and an error is suppressed in recording/reproducing data into the flexible disk FD. Furthermore, as shown in FIG. 9A, the center hole 61c of the center core 61 engages in the protrusion 31 formed on the lower face 30a of the upper plate 30, and thereby, a shift in a diametrical direction of the flexible disk FD is suppressed, and the flexible disk FD is not damaged.

When the magnetic disk cartridge 1 is inserted in the disk drive D, it is inserted, making it front an insertion direction shown in FIG. 1. Then according to the insertion movement, as shown in FIG. 8A, the drive gear 110 of the disk drive D proceeds into the groove 18, abuts with the lock release leg portion 64c of the lock spring 64, and releases the engagement of the lock leg portion 64a and the driven gear 41a. If the drive gear 110 proceeds further back into the groove 18, as shown in FIG. 8B, it engages with the driven gear 41a, rotates the driven gear 41a, that is, rotates the rotary shutter 40.

If the rotary shutter 40 rotates, the engagement protrusion 42c (see FIG. 3) thereof engages in the engagement hole portion 52 (see FIG. 3) of the swing shutter 50, pushes and moves the swing shutter 50, and thus swings the shutter 50 clockwise in FIG. 6. By the swing shutter 50 being swung, the chucked center hole C3 opens, and as shown in FIG. 2, the center core 61 is exposed outside from the hole C3.

At this time, because the rotary shutter 40 contacts the lower plate 20 at the contact rib 41b formed along a circumference as shown in FIG. 6, it smoothly rotates. In addition, although the swing shutter 50 rotates between the rotary shutter 40 and the lower plate 20, it is enabled to swing without interfering the contact rib 41b while maintaining the smooth rotation of the rotary shutter 40 because the shutter 50 swings in a range of the window portion 41b′, where the contact rib 41b is cut off. Then as shown in FIG. 9B, the center core 61 is detached from the protrusion 31 of the upper plate 30 and can freely move. Simultaneously, the opening of the shutter member 41 matches the access opening C2 by the rotation itself of the rotary shutter 40, and thus the flexible disk FD is made to front outside from the opening C2.

Then, the spindle SP of the disk drive D couples the center core 61 by magnetic attraction, and holds the magnetic disk media DM. At this time the center protrusion SP1 of the spindle SP engages in the center hole 61c of the center core 61, and thereby, the center is matched. In addition, the flexible disk FD is substantially positioned at center in the up/down directions (thickness directions) of the cartridge case C. Therefore, when rotating the magnetic disk media DM, an air flow above/below the flexible disk FD becomes stable, and a face vibration of the disk FD is suppressed.

Next, the magnetic disk media DM starts to rotate by the rotation of the spindle SP. The swing arm SA of the disk drive D proceeds into the cartridge case C from the access opening C2 opened at right side of the magnetic disk cartridge 1, and the magnetic head H provided at the swing arm SA is loaded on the flexible disk FD.

After data recording/reproducing is performed by the magnetic head H, the swing arm SA retracts from the cartridge case C and the head H is unloaded. In addition, the spindle SP is detached from the center core 61. When removing the magnetic disk cartridge 1 from the disk drive D, a reverse movement for the insertion is performed. In other words, by a movement of pulling the magnetic disk cartridge 1 out of the disk drive D, the drive gear 110 rotates the rotary shutter 40 in a closing direction thereof, and by the rotational movement, the engagement protrusion 42c of the rotary shutter 40 engages in the engagement hole portion 52 of the swing shutter 50, pushes and moves the swing shutter 50, and swings the shutter 50 counterclockwise in FIG. 6. By the swing movement the chucked center hole C3 is closed by the swing shutter 50. At this time, as shown in FIG. 9B to FIG. 9A, the swing shutter 50 abuts with the conical face 61d of the center core 61 and pushes the magnetic disk media DM into the cartridge case C. Then the center hole 61c of the center core 61 and the protrusion 31 engage, and the magnetic disk media DM is fixed within the cartridge case C.

In addition, the drive gear 110 retracts from the groove 18, the state of FIG. 8B to that of FIG. 8A; thereby, the engagement of the lock release leg portion 64c of the lock spring 64 with the gear 110 is released, the lock leg portion 64a of the lock spring 64 rotates clockwise in FIG. 6, engages in the driven gear 41a, and locks the rotation of the rotary shutter 40.

In accordance with the magnetic disk cartridge 1 of the embodiment thus described, the following effects are obtained.

Firstly, because the access opening C2 is not provided at-the lower plate 20 and the upper plate 30 and is formed at a side portion, to be more precise, the side portion of the base frame 10, the opening of the cartridge case C suffices to be minimum and it is difficult for dust to invade the magnetic disk cartridge 1. In addition, because the magnetic disk cartridge 1 is enabled to only front the side face of the magnetic disk media DM from the access opening C2 and not enabled to directly touch the recording face of the flexible disk FD with a hand and the like, it does not also occur to abruptly taint and damage the flexible disk FD. Accordingly, in the magnetic disk cartridge 1 an error is difficult to occur by the dust, and the taint and damage.

Because the rotary shutter 40 is disposed inside the base frame 10 and the outer perimeter of the shutter 40 is disposed more inside than the rim portions of the lower plate 20 and the upper plate 30, the shutter 40 is not hooked from outside and moved in no use of the magnetic disk cartridge 1.

In addition, because the swing shutter 50 is actuated inside the lower plate 20 and closes the chucked center hole C3, it is not hooked into an outside thing and does not abruptly open. Particularly, because the swing shutter 50 is designed so as to close the chucked center hole C3 with a single member, it is difficult to be hooked into an outside thing.

Because the ribs 14 formed around the base frame 10 are disposed at the perimeters of the lower plate 20 and the upper plate 30 and the height of the ribs 14 is larger than the thicknesses of the lower plate 20 and the upper plate 30, their rims 29 and 39 are not hooked into an outside thing.

Because the rotary shutter 40 contacts the lower plate 20 by the contact rib 41b formed along the circumference, a smooth rotational movement is enabled. Furthermore, because the part of the contact rib 41b is cut off not to prevent the swing movement of the swing shutter 50 and forms the window portion 41b′, the movement of the shutter 50 is also good.

In addition, although the rotary shutter 40 comprises the reinforcement plate 42 only at side of the lower plate 20, it enables a stable rotational movement thereof and contributes to thin the magnetic disk cartridge 1. Furthermore, by comprising the reinforcement plate 42 only at the side of the lower plate 20, it is enabled to assemble the magnetic disk cartridge 1 by a method of building up the rotary shutter 40, the magnetic disk media DM, and the upper plate 30 from the lower plate 20 and to realize a simplification of the assembly.

Furthermore, the rotational movement of the rotary shutter 40 is transmitted to the swing movement of the swing shutter 50 by the engagement of the engagement protrusion 42c formed at the reinforcement plate 42 and the engagement hole portion 52 of the swing shutter 50, and the rotary shutter 40 and the swing shutter 50 can be simultaneously moved only by the operation of moving the rotary shutter 40 from outside. Although the engagement protrusion 42c slightly protrudes from the engagement hole portion 52 in some case, because an interference between the protruded portion and the lower plate 20 can be evaded by the evasion groove 22 formed at the lower plate 20, the smooth rotational movement of the rotary shutter 40 is ensured, and it is also enabled to prevent the occurrence of dust due to the contact of the engagement protrusion 42c and the lower plate 20.

Because the center core 61 engages in the protrusion 31 in no use of the magnetic disk cartridge 1, the magnetic disk media DM is fixed and not damaged. Therefore, it is enabled to minimize a clearance between the magnetic disk media DM and the base frame 10, to enlarge the size of the disk media DM, and to enlarge a memory capacity thereof.

Because the access opening C2 is provided in an orthogonal direction for the insertion direction of the magnetic disk cartridge 1, right in the embodiment, it is enabled to dispose such the swing arm SA right and to lessen the depth of the disk drive D. Therefore, it is enabled to realize the disk drive D of a card type that is thinner and smaller in depth.

Thus although one embodiment of the present invention is described, the invention can be performed, changed as needed, and it goes without saying that the invention is not limited to the embodiment.

For example, recording disk media may also be optical disk media such as magneto-optical disk media and phase-change disk media, not limited to magnetic disk media; and disk media having a rigidity such as a DVD-DRAM, not limited to flexible disk media.

In addition, although in the embodiment the swing shutter 50 is supported swingably by the lower plate 20, it may also be designed to be supported swingably by the upper plate 30 or the base frame 10.

Furthermore, although the reinforcement plate 42 is configured with a separate metal plate from the shutter member 41, they can also be integrally molded by resin and the like.

In addition, the drive gear is not limited to one fixed within the disk drive D, and may also be rotationally driven one.

What is claimed is:

1. A recording disk cartridge having recording disk media and a cartridge case for housing the recording disk media, the cartridge comprising:
a base frame for substantially surrounding a radial directional outside of said recording disk media, configuring a sidewall of said cartridge case, and comprising a side opening that makes said recording disk media front outside;
a lower plate disposed below said recording disk media and for configuring a lower wall of said cartridge case, wherein a chucked center-hole is formed in order to couple a spindle of a disk drive with said recording disk media;
an upper plate disposed above said recording disk media and for configuring an upper wall of said cartridge case;
a rotary shutter for opening and closing said side opening by rotating within said cartridge case; and
a swing shutter disposed between said recording disk media and said lower plate and engaged in said rotary shutter, for swinging in response to a rotational movement of said rotary shutter, and for opening and closing said chucked center hole,
wherein said rotary shutter comprises a reinforcement plate only at a lower side thereof.

2. The recording disk cartridge according to claim 1, wherein said rotary shutter comprises an outer perimeter wall made of resin substantially surrounding a radial directional outside of said recording disk media; and said reinforcement plate made of metal fixed at a lower side of said outer perimeter wall.

3. The recording disk cartridge according to claim 2, wherein said outer perimeter wall and said reinforcement plate are integrally molded by insert molding.

4. The recording disk cartridge according to claim 1, wherein said reinforcement plate comprises a cylindrical engagement protrusion protruded downward in order to engage in said rotary shutter, a liner for cleaning is provided on an upper face of the reinforcement plate, and an opening of said engagement protrusion is occluded.

5. The recording disk cartridge according to claim 2, wherein said reinforcement plate comprises a cylindrical engagement protrusion protruded downward in order to engage in said rotary shutter, a liner for cleaning is provided on an upper face of the reinforcement plate, and an opening of said engagement protrusion is occluded.

6. The recording disk cartridge according to claim 3, wherein said reinforcement plate comprises a cylindrical engagement protrusion protruded downward in order to engage in said rotary shutter, a liner for cleaning is provided on an upper face of the reinforcement plate, and an opening of said engagement protrusion is occluded.

7. The recording disk cartridge according to claim 4, wherein said engagement protrusion is formed by barring process of a metal plate configuring said reinforcement plate.

8. The recording disk cartridge according to claim 5, wherein said engagement protrusion is formed by barring process of a metal plate configuring said reinforcement plate.

9. The recording disk cartridge according to claim 6, wherein said engagement protrusion is formed by barring process of a metal plate configuring said reinforcement plate.

10. The recording disk cartridge according to claim 4, wherein said swing shutter comprises an engagement hole that engages in said engagement protrusion and swings said swing shutter in response to a rotational movement of said rotary shutter.

11. The recording disk cartridge according to claim 5, wherein said swing shutter comprises an engagement hole that engages in said engagement protrusion and swings said swing shutter in response to a rotational movement of said rotary shutter.

12. The recording disk cartridge according to claim 6, wherein said swing shutter comprises an engagement hole that engages in said engagement protrusion and swings said swing shutter in response to a rotational movement of said rotary shutter.

13. The recording disk cartridge according to claim 4, wherein said rotary shutter comprises at an outer perimeter a driven gear for engaging in a drive gear comprised by said disk drive, and for performing said rotational movement, and wherein said base frame comprises a shutter actuation opening for exposing said driven gear sideward.

14. The recording disk cartridge according to claim 5, wherein said rotary shutter comprises at an outer perimeter a driven gear for engaging in a drive gear comprised by said disk drive, and for performing said rotational movement, and wherein said base frame comprises a shutter actuation opening for exposing said driven gear sideward.

15. The recording disk cartridge according to claim 6, wherein said rotary shutter comprises at an outer perimeter a driven gear for engaging in a drive gear comprised by said disk drive, and for performing said rotational movement, and wherein said base frame comprises a shutter actuation opening for exposing said driven gear sideward.

16. The recording disk cartridge according to claim 11, wherein said rotary shutter comprises at an outer perimeter a driven gear for engaging in a drive gear comprised by said disk drive, and for performing said rotational movement, and wherein said base frame comprises a shutter actuation opening for exposing said driven gear sideward.

17. The recording disk cartridge according to claim 12, wherein said rotary shutter comprises at an outer perimeter a driven gear for engaging in a drive gear comprised by said disk drive, and for performing said rotational movement, and wherein said base frame comprises a shutter actuation opening for exposing said driven gear sideward.

18. The recording disk cartridge according to claim 1, wherein said recording disk media is magnetic disk media.

19. The recording disk cartridge according to claim 1, wherein said recording disk media is magneto-optical disk media.

20. The recording disk cartridge according to claim 1, wherein said recording disk media is phase-change disk media.
